(19) United States
(12) Patent Application Publication
(10) Pub. No.: US 2015/0252930 A1
(43) Pub. Date: Sep. 10, 2015

(54) MAGNETIC CONNECTOR FOR A VAPORIZER

(71) Applicant: Matthew H. Martin, Lomita, CA (US)

(72) Inventor: Matthew H. Martin, Lomita, CA (US)

(21) Appl. No.: 14/196,110

(22) Filed: Mar. 4, 2014

(51) Int. Cl. F16L 37/00; F16L 21/04; F16L 33/30; F16L 21/03

(52) U.S. Cl. CPC F16L 37/004; F16L 21/03; F16L 21/04; F16L 33/30

(57) ABSTRACT

An adjustable hose connection relying on magnetic force to maintain seal is disclosed. The hose connection can be for connecting a vapor source, such as a nebulizer or hookah water pipe, to a delivery hose. The hose connection includes a male and female connector and a rubber seal between them. Both connectors have a magnetic element that attract to provide a seal and connection. The magnetic elements are preferably a permanent magnet in one of the connectors while the opposite magnetic element can be a ferromagnetic material such as steel. The strength of this connection can be varied by adjusting the magnetic gap between the male and female connectors with a threaded adjuster. The connection can thus be adjusted to find the optimal balance between seal strength and ease of disconnection in various environments.

### BACKGROUND

Vapor from a nebulizer or hookah source is usually delivered via a threaded or press fit hose connection. While this type of connection provides an adequate seal, it also makes the vapor source and surrounding area prone to damage from the hose being pulled too hard inadvertently. This is especially true for hookah water pipes that are often tall, unstable, and filled with hot coals and dirty water.

One existing solution is place the hookah within a stable wooden stand to prevent it from tipping over. While this solution does prevent a hookah from tipping over, it leaves much to be desired because of the bulky nature of the stand and high cost of the product. It is also challenging to design a solution that fits many various sized hookah water pipes. Some hookahs are larger or smaller than others and hookah hoses can vary significantly in length, weight, and overall size. The present disclosure is aimed at overcoming the problems set forth above.

### SUMMARY OF THE INVENTION

An adjustable hose connection for a vaporizer relying on magnetic force to maintain an airtight seal is disclosed. The hose connection can be for connecting a vapor source, such as a nebulizer or hookah water pipe, to a delivery hose. The hose connection includes a male and female connector and a rubber seal between them. Both connectors have a magnetic element that attract to each other to provide a seal and connection. The magnetic element preferably is a permanent or electromagnet magnet in one of the connectors while the opposite connector magnetic element can be a ferromagnetic material such as steel or a permanent magnet. In a preferred embodiment, the strength of the coupling force can be varied by adjusting the magnetic gap between the male and female connectors with a threaded adjust mechanism. The connection can be adjusted to find the optimal balance between seal strength and ease of disconnection in various circumstances and environments. Either the male or female connectors may also include an adapter to accept a hookah hose or an adapter to accept flexible rubber tubing. Thus the presented invention provides an economical and universal solution to providing an adequate sealing hose connection that can be adjusted disengage when too much non axial force is applied to it.

### BRIEF DESCRIPTION OF THE DRAWINGS

FIG. 1 is a cross-sectional view of a first preferred embodiment of the present invention;

FIG. 2 is an enlarged, perspective view of a coupling using the present invention;

FIG. 3 is an enlarged, perspective view of the coupling of FIG. 2 after disconnection;

FIG. 4 is a cross-sectional view of an adjustment mechanism to control the coupling force of the present invention;

FIG. 5 is a cross-sectional view of the embodiment illustrating the disconnect of the coupling;

FIG. 6 is an exploded view of the embodiment of FIG. 1; and

FIG. 7 is a cross sectional view of the engagement of the coupling mechanism with a hose.

### DETAILED DESCRIPTION OF THE PREFERRED EMBODIMENTS

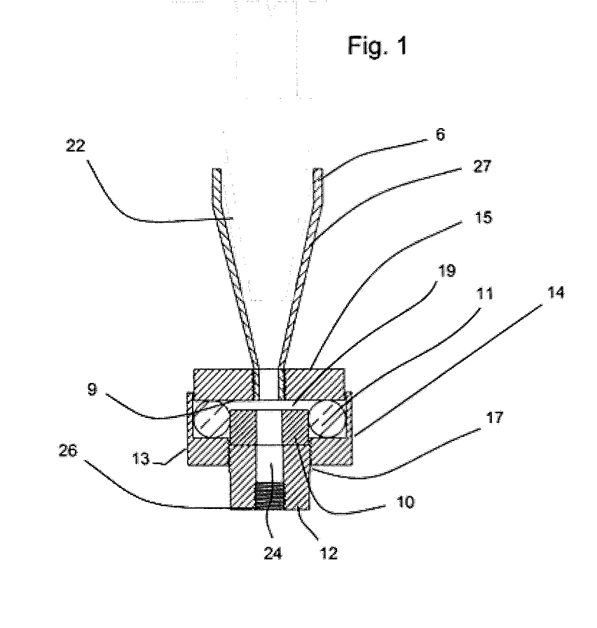

Referring to FIG. 1, the cross-sectional view of a first preferred embodiment of an adjustable magnetic hose connector is shown. An cylindrical female connector 14 has a magnetic element 10, which is preferably a rare earth permanent magnet, and the male connector 15 is preferably a ferromagnetic material such as steel. The male connector 15 could also incorporate a permanent magnet oriented to attract the magnetic element 10. A sealing member 11, which can be a rubber O-ring, provides a seal between the female connector 14 and male connector 15. The magnetic attraction between the magnetic element 10 in the female connector 14 and the male connector 15 provides a secure coupling and seal between the two components. The strength of this coupling can be adjusted by changing the length of the magnetic gap 19 between the magnetic element 10 and male connector 15.

The female connector 14 is may be comprised of a cylindrical base 12 and a socket 13 that are threaded together via mating threaded engagement 17, and are both made out of a suitable material such as metal or plastic. The magnetic element 10 may be affixed to the top of the base 12 using an adhesive, a press fit, clasp, or other attachment means, while the sealing element 11 sits on the bottom of the socket 13. The rim of the socket 13 extends above the sealing element 11 by a small amount to provide centering action on the male connector 15. A delivery hole 24 runs through the center of the female connector 14 for vapor delivery. The inside of the delivery hole 24 may also include threads 26 to attach to a hookah 8 or other vapor source. The outside surface of the base 12 below the threaded portion 17 can also be knurled or advantageously shaped to make it easier for the user to grab and turn the components.

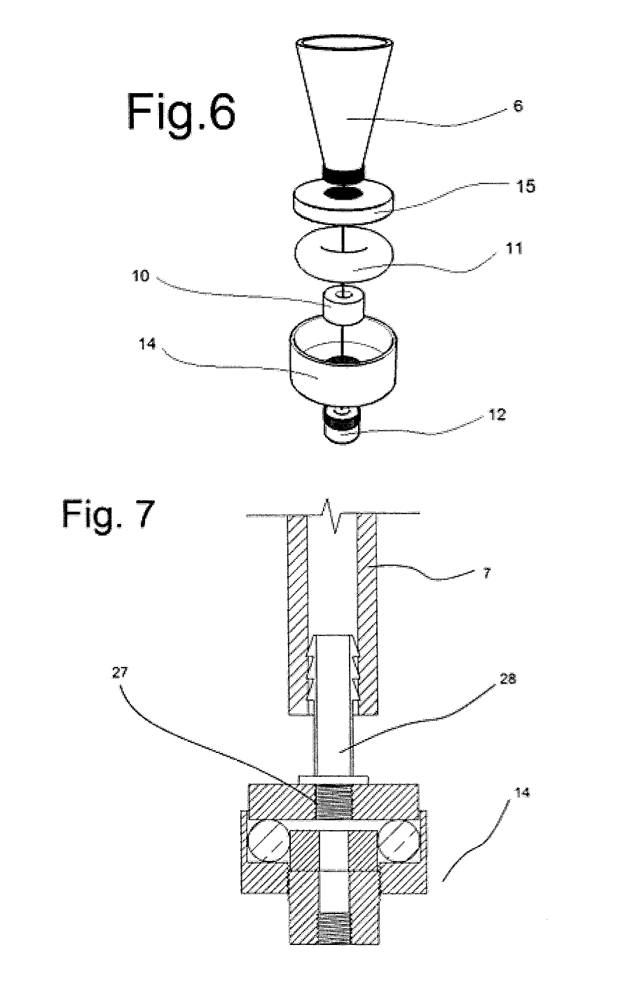

The male connector 15 includes a sealing surface 9. The sealing surface 9 can be made out of plastic or metal, and fits within the socket 13 of the female connector 14. In the present embodiment, the sealing surface 9 of the male connector 15 is a circular, coin or washer-shaped steel fitting with a threaded center hole (see FIG. 6) which may connect easily to a conventional hookah hose stem adapter 6. The hose adapter 6 can accept nearly any hookah delivery hose 7 and is sealed with a rubber hose seal 22. The sealing surface 9 of the male connector 15 can likewise be connected directly to a delivery hose 7.

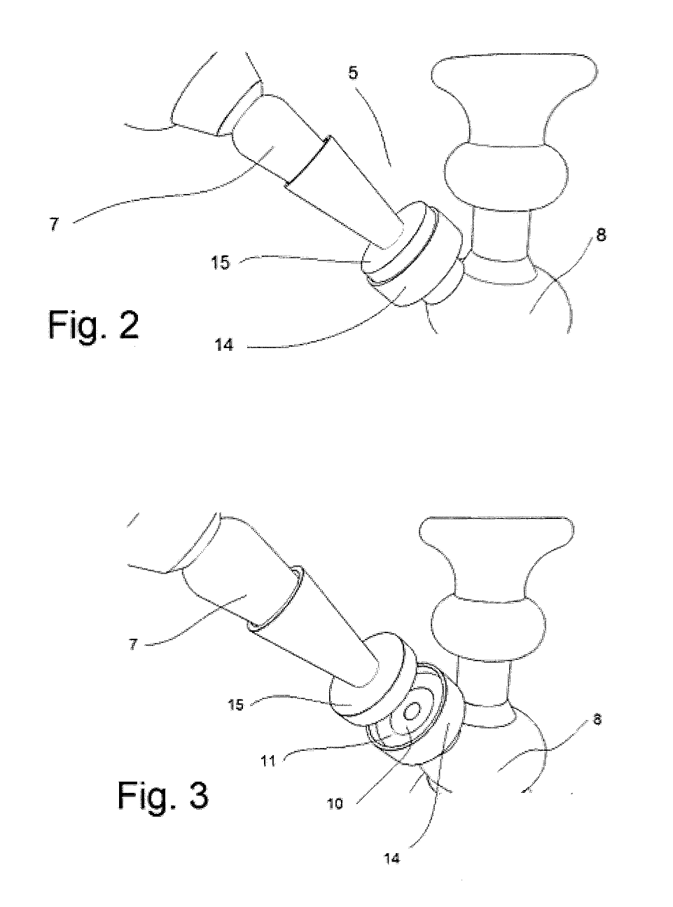

FIG. 2 illustrates a perspective view of an adjustable magnetic hose connector 5 in its connected position. The hookah 8 is connected to a delivery hose 7 by the adjustable magnetic hose connector 5. FIG. 3 illustrates a perspective view of the delivery hose 7 separated from the vaporizer 8, such as might occur when too much force is applied to the hose. Instead of the vaporizer 8 falling over, which could lead to damage to the vaporizer or the user, the adjustable male connector 15 simply detaches from the female connector 14 through loss of the magnetic coupling.

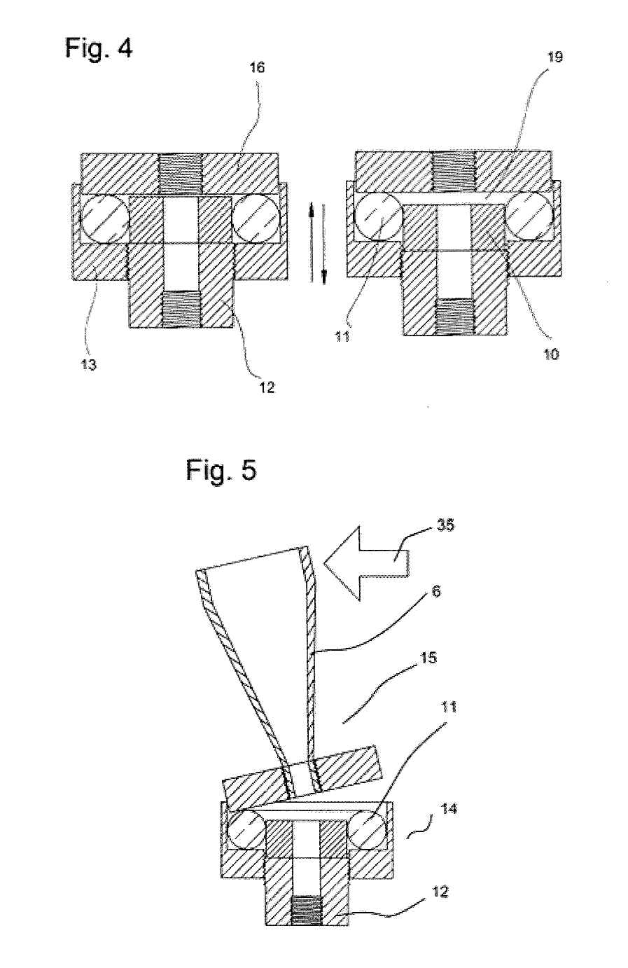

In FIG. 4 is a cross sectional side view that shows how a magnetic gap 19 can be adjusted by moving the base 12 and the socket 13 closer together or farther apart through the rotation and counter-rotation of the threaded engagement between the base 12 and socket 13. The adjustment of the magnetic gap between the magnetic element 10 and the male connector 15 serves to vary the strength of the seal between the two components and the amount of force it takes to disengage them. For a more secure connection, the socket 13 is raised closer to the male connector 15, whereas a lighter connection is achieved by creating greater separation between the two.

FIG. 5 illustrates how a non-axial force (represented by arrow 35) exerted on the hose adapter 6 causes the male connector 15 to disconnect from the female connector 14. Here, the torque on the connection caused by the force 35 leads to the de-coupling of the magnetic connection at a first edge. Further force continues the separation and decoupling, resulting in a complete decoupling of the connector to the vaporizer 8. It should be noted that the force represented by arrow 35 is small compared with the force required to tip the vaporizer over, such that disconnection will occur well in advance of the toppling of the vaporizer.

FIG. 6 is an exploded view of the first preferred embodiment of an adjustable magnetic hose connector. The hose adapter 6 is connected to the male connector 16, preferably through a releasable connection so that the connector can be removed and used again with other vaporizers and/or hoses. The male connector, which may either be magnetic itself, or simply ferromagnetic so as to be attracted by the magnetic element 10 in the female connector 14, fits into the socket 13 of the female connector 14. A sealing element 11 is provided to establish an airtight seal between the male and female connectors.

FIG. 7 illustrates an alternate embodiment of an adjustable magnetic hose connector, wherein a hose barb 28 is threaded into the threaded attachment hole 27 of the male connector 15. A vapor delivery hose 7 can then be connected to the hose barb 28.

The foregoing features and illustrations are intended to be exemplary and not limiting. Except as otherwise expressly indicated, nothing in the description should taken as limiting the present invention to the exemplary embodiments or those embodiments depicted in the drawings.

I Claim:

1. A vaporizer system having a vaporizer and a delivery hose, and a magnetic coupling between the vaporizer and delivery hose, comprising:
a female connector having a base and a socket connected by an adjustable connection to adjustably vary a length of the female connector;
a magnetic element disposed within the socket of the female connector;
an O-ring disposed about the magnetic element within the socket of the female connector;
a male connector having a first end adapted to fit within the socket of the female connector, the first end having a magnetic attraction to the magnetic element; and
a hose adapter connected to the male connector.

2. The vaporizer system of claim 1, wherein the adjustable connection between the base and the socket is a threaded connection.

3. The vaporizer system of claim 1, wherein the magnetic element is a permanent magnetic.

4. The vaporizer system of claim 1, wherein the first end of the male connector is ferromagnetic.

5. The vaporizer system of claim 1, wherein the first end of the male connector includes a permanent magnet.

6. The vaporizer system of claim 1, wherein the vaporizer is a hookah pipe.

7. The vaporizer system of claim 1, wherein the male connector includes a barbed element.

8. The vaporizer system of claim 1, wherein a length of the female connector is selected to establish a disconnect force that is less than a magnitude of a force needed to tip over the vaporizer.
